(19) United States
(12) Patent Application Publication
(10) Pub. No.: US 2026/0089050 A1
(43) Pub. Date: Mar. 26, 2026

(54) UTILIZING MACHINE LEARNING MODELS TO GENERATE PREDICTED REFEREE INTERACTION METRICS FOR GENERATING AND TRANSMITTING DIGITAL NOTIFICATIONS ACROSS COMPUTER NETWORKS TO REFERRER CLIENT DEVICES

(71) Applicant: Chime Financial, Inc., San Francisco, CA (US)

(72) Inventors: Akshat Khandelwal, San Francisco, CA (US); Jason Michael Lee, San Francisco, CA (US); Li-Ping Chin, San Francisco, CA (US); Andrew Robert Ratcliffe, San Francisco, CA (US); Lin-Yu Tai, San Francisco, CA (US); Hadi Ramezani-Dakhel, San Francisco, CA (US)

(21) Appl. No.: 18/903,713

(22) Filed: Oct. 1, 2024

Related U.S. Application Data
(60) Provisional application No. 63/698,832, filed on Sep. 25, 2024.

(51) Int. Cl. H04L 41/06; G06F 9/54

(52) U.S. Cl. CPC H04L 41/06; G06F 9/542; G06F 2209/541

(57) ABSTRACT

The present disclosure relates to systems, non-transitory computer-readable media, and methods for utilizing machine learning to generate predicted referee interaction metrics for building a digital notification distribution policy for tiers of referrer client devices and transmitting digital notifications to referrer client devices across computer networks. In particular, in one or more embodiments, the disclosed systems utilize a referee interaction prediction machine learning model that generate predicted referee interaction metrics indicating likelihoods of downstream interactions of referee client devices based on features of referrer client devices. The disclosed systems generate referrer client device tiers for referrer client devices based on the predicted referee interaction metrics and then utilizes an optimization model to generate a digital notification distribution policy for the tiers of the referrer client devices. Further, the disclosed systems transmit digital notifications to referrer client devices in accordance with the digital notification policy and the referrer client device tiers.

### CROSS-REFERENCE TO RELATED APPLICATIONS

This application claims priority to and the benefit of U.S. Provisional Patent Application No. 63/698,832, filed on Sep. 25, 2024, which is incorporated herein by reference in its entirety.

### BACKGROUND

Recent years have seen significant improvements in digital content distribution systems. For instance, conventional content distribution systems utilize automated workflows or triggers to send digital content upon detecting triggering events associated with an automated workflow or trigger. In addition, because they integrate with various communication systems, such as social media networks or email systems, conventional digital content distribution systems can quickly disseminate digital notifications across numerous communication streams and, therefore, multiple client devices in response to a single event. Further, conventional digital content distribution systems utilize codes or tokens unique to a client device or user account, allowing for traceability and attribution of digital content corresponding to subsequent client device interactions. However, several problems still exist regarding conventional digital content distribution systems, particularly regarding the accuracy, efficiency, and flexibility of implementing computing devices.

### SUMMARY

Embodiments of the present disclosure provide benefits and/or solve one or more of the foregoing or other problems in the art with systems, non-transitory computer-readable media, and methods for utilizing machine learning models to generate predicted referee interaction metrics for downstream referee client devices and generating a digital notification policy for transmitting digital notifications to corresponding referrer client devices. In particular, in one or more embodiments, the disclosed systems utilize machine learning to generate predicted interaction metrics indicating predicted interactions of downstream referee client devices based on features of referrer client devices. Based on the predicted interaction metrics for downstream referee client devices, the disclosed systems can generate tiers for referrer client devices and utilize an optimization model to generate a digital notification distribution policy for transmitting digital notifications to referrer client devices in accordance with the tiers. In some embodiments, the disclosed systems generate the digital notification distribution policy from measured interactions of referee client devices and a target interaction metric. Additional features and advantages of one or more embodiments of the present disclosure are outlined in the description that follows and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an intelligent digital content distribution system can operate in accordance with one or more embodiments.

FIG. 2 illustrates an overview of an intelligent digital content distribution system utilizing a referee interaction predicting machine learning model and distributing digital notifications in accordance with one or more embodiments.

FIGS. 3A-3B illustrate an example sequence flow of an intelligent digital content distribution system utilizing and training a referee interaction predicting machine learning model to generate predicted referee interaction metrics in accordance with one or more embodiments.

FIG. 4 illustrates an example sequence flow of an intelligent digital content distribution system utilizing an optimization model in accordance with one or more embodiments.

FIG. 5 illustrates an example sequence flow of a digital notification distribution policy of an intelligent digital content distribution system in accordance with one or more embodiments.

FIG. 6 illustrates an example graphical user interface of an intelligent digital content distribution system providing a digital notification to a referrer client device in accordance with one or more embodiments.

FIG. 7 illustrates a flowchart of a series of acts for utilizing machine learning to generate predicted interaction metrics for potential referrer client devices and generating a digital notification policy for transmitting digital notifications to the referrer client devices in accordance with one or more embodiments.

FIG. 8 illustrates a block diagram of an example computing device for implementing one or more embodiments of the present disclosure.

FIG. 9 illustrates an example environment for an inter-network facilitation system in accordance with one or more embodiments.

### DETAILED DESCRIPTION

This disclosure describes one or more embodiments of an intelligent digital content distribution system that utilizes machine learning to generate predicted referee interaction metrics for building a digital notification distribution policy for tiers of referrer client devices and transmitting digital content to referrer client devices across computer networks. Specifically, in one or more embodiments, the intelligent digital content distribution system utilizes a referee interaction prediction machine learning model that analyzes features of referrer client devices to generate predicted referee interaction metrics indicating probabilities or likelihoods of future interactions of referee client devices. Based on the predicted referee interaction metrics, the intelligent digital content distribution system generates tiers of referrer client devices and then utilizes an optimization model to generate a digital notification distribution policy for the tiers of the referrer client devices. Moreover, in one or more implementations, the intelligent digital content distribution system transmits digital notifications to referrer client devices in accordance with the digital notification policy and the referrer client device tiers.

As just mentioned, in one or more embodiments, the intelligent digital content distribution system utilizes a referee interaction prediction machine learning model. In particular, the intelligent digital content distribution system utilizes a referee interaction prediction machine learning model (e.g., a decision tree model such as gradient boost) that is trained to generate predicted referee interaction metrics indicating likelihoods (or predictions) for downstream interactions of a referee client device based on features of a referrer client device. In some cases, the referee interaction prediction machine learning model works together with additional trained interaction prediction machine learning models to generate the predicted referee interaction metrics to, for instance, generate various predicted referee interaction metrics corresponding to different interaction types. The intelligent digital content distribution system can then combine (or weight) the pluralities of predicted referee interaction metrics to generate predicted referee interaction metrics.

As also previously mentioned, in one or more embodiments, the intelligent digital content distribution system generates tiers for referee client devices based on the predicted referee interaction metrics. Specifically, the intelligent digital content distribution system generates a ranked order of the predicted referee interaction metrics and identifies tier thresholds based on the ranked order to use in separating (or aggregating) predicted referee interaction metrics into corresponding referrer client device tiers.

In addition, in one or more embodiments, the intelligent digital content distribution system utilizes measured referee client device interactions to generate a digital notification distribution policy. In some embodiments, the intelligent digital content distribution system generates measured referee client device interactions by providing a set of digital notifications with corresponding referrer invitation values to test referrer client devices and measuring corresponding (or subsequent) interactions of referee client devices associated with (e.g., receive an invitation from) the test referrer client device. The intelligent digital content distribution system can utilize the referrer client device tiers to generate a referrer client device tier database by aggregating the measured referee client device interactions according to the referrer client device tiers and referrer invitation values transmitted to historical referrer client devices of the measured device interactions.

The intelligent digital content distribution system can utilize the referrer client device tier database to generate the digital notification distribution policy for the referrer client device tiers. For example, in one or more implementations, the intelligent digital content distribution system utilizes an optimization model to generate the digital notification distribution policy from the referrer client device tier database. To illustrate, in one or more implementations, the intelligent digital content distribution system identifies a target interaction metric (e.g., based on user interaction at an administrator device). The intelligent digital content distribution system 102 then utilizes the optimization model to analyze different referrer invitation values across different referrer client device tiers to model a combination of referrer invitation values that are predicted to result in the target interaction metric. In this manner, the intelligent digital content distribution system utilizes the optimization model to generate (or assign) referrer invitation values to the referrer client device tiers based on the referrer client device tier database.

In one or more embodiments, the intelligent digital content distribution system utilizes the digital notification distribution policy as a guide for referrer invitation values to include in digital notifications to referrer client devices. For example, the intelligent digital content distribution system utilizes the referee interaction prediction machine learning model to generate a predicted referee interaction metric for a candidate client device based on features of the candidate client device. Using the predicted referee interaction metric, the intelligent digital content distribution system can select a referrer client device tier and corresponding referrer invitation value, then transmit a digital notification that includes the referrer invitation value to the referrer client device.

As previously mentioned, while conventional digital content distribution systems can disseminate and track digital content, digital content distribution systems still suffer from several problem and shortcomings. For example, conventional digital content distribution systems are inaccurate. Conventional digital content distribution systems send digital notifications (such as digital referral messages) based on detecting triggering events associated with an automated workflow or trigger. However, while triggering events offer some indication that a referrer client device will interact with a digital notification, digital notifications based on triggering events often fail to elicit an anticipated impact. Indeed, conventional digital content distribution systems that send digital transmissions to referrer client devices are often not utilized, resulting in wasted bandwidth and computer resources.

Indeed, in part due to their inaccuracy, conventional digital content distribution systems are inefficient. Because, as mentioned, digital content distribution systems send digital referrals that are often not utilized, conventional digital content distribution systems expend excessive computing power generating and transmitting digital notifications. Moreover, computing devices that receive and never interact with a digital notification also require excess computing power to continually sync and update unread messages, needlessly consuming bandwidth and other computing resources to repeatedly display and store ignored messages. Over time, the accumulation of messages can tax storage capacities and expend energy for data management for computing systems of the referrer device and backup (or cloud) systems that unnecessarily duplicate and store unread messages.

In addition, conventional digital content distribution systems are inflexible. As mentioned, conventional digital content distribution systems send digital notifications based on triggering events. For example, conventional digital content distribution systems distribute digital referrals through the use of pre-configured action templates that rigidly define triggering events and corresponding digital notifications to send in response to the triggering events. Indeed, conventional digital notification systems have stock templates for generic (or standard) digital notifications to send in response to the triggering event, often with standard values or other incentives for referrer client devices to interact with the digital notification. However, as mentioned, rigidly sending these generic digital notifications to referrer client devices fails to have an anticipated impact and causes computing system inefficiencies. These, along with additional problems and issues, exist with regard to conventional digital content distribution systems.

As suggested above and as described in further detail below, the intelligent digital content distribution system provides a variety of technical advantages relative to conventional digital content distribution systems. For instance, unlike conventional digital content distribution systems that fail to have an anticipated impact, the intelligent digital content distribution system improves accuracy relative to conventional systems. Specifically, the intelligent digital content distribution system utilizes multiple components, including one or more referee interaction prediction machine learning models, an optimization model, and a digital notification policy, that work together to generate digital notifications to referrer client devices that referrer client devices are much more likely to interact with. For example, the intelligent digital content distribution system utilizes the referee interaction prediction machine learning models to generate predicted referee interaction metrics that accurately indicate predicted interactions of referee client device interactions based on features of referrer client devices. Further, the intelligent content distribution system then uses optimization model to generate referrer invitation values and generate a digital notification distribution policy for transmitting digital notifications with referrer invitation values to referrer client devices. Indeed, by training and updating the referee interaction prediction machine learning models to generate accurately predicted referee interaction metrics, the intelligent digital content distribution system can build tiers that predict or anticipate client devices that will interact with digital notifications and, therefore, elicit an anticipated impact.

In addition, the intelligent digital content distribution system improves efficiency relative to conventional digital content distribution systems. For example, unlike conventional digital content distribution systems that expend excess energy on digital referrals that are often unutilized, the intelligent digital content distribution system generates digital notifications that a referrer client device is more likely to access. Specifically, the intelligent digital content distribution system utilizes a referee interaction prediction machine learning models that generate accurately predicted referee interaction metrics and utilizes an optimization model to generate referrer invitation values for referrer client device tiers based on the predicted referee interaction metrics. By using this approach, the intelligent digital content distribution system generates digital notifications for candidate referrer client devices with a referrer invitation value with which referrer client devices are more likely to interact. Thus, the intelligent digital content system does not require the excess computing power and bandwidth to transmit and store unnecessary messages.

Further, the intelligent digital content distribution system improves flexibility relative to conventional digital content distribution systems. For instance, unlike conventional digital content distribution systems that rigidly send generic digital referrals to referee client devices, the intelligent digital content distribution system generates and distributes digital notifications with varying referrer invitation values. Specifically, by using referee interaction prediction machine learning models to generate predicted referee interaction metrics and then selecting a referrer client device tier for a referrer client device, the intelligent digital content distribution system can tailor digital notifications for referrer client devices. Indeed, unlike the generic or stock digital referrals of conventional digital content distribution systems, the intelligent digital content distribution system generates digital notifications with intelligently selected referrer invitation values for the referrer client devices.

In addition to tailoring digital notifications to specific client devices, the intelligent digital content distribution system also flexibly modifies policies to achieve certain interaction metrics. In particular, the intelligent digital content distribution system utilizes an optimization model that generates referrer invitation to achieve particular target interaction metrics. Indeed, the intelligent digital content distribution system adjusts referrer invitation values based simply on receiving an updated target interaction metric.

As illustrated by the foregoing discussion, the present disclosure utilizes a variety of terms to describe the features and advantages of the intelligent digital content distribution system. Additional details regarding the meaning of such terms are now provided. For example, as used herein, the term “referrer client device” refers to a computing device associated with a referrer (or candidate/potential referrer). Thus, a referrer client device includes a client device that receives (or is analyzed/considered to receive) a digital notification that includes a referral invitation value. For instance, a referrer client device can receive a digital notification that includes a referral invitation value and transmit a digital notification to another computing device (e.g., a referee client device) to connect with, interface with, activate access to, register credentials for, or initialize an account for an inter-network facilitation system. In some cases, a referrer client device sends or provides the invitation to another computing device by selecting an option in a digital notification, and upon selection, the inter-network facilitation system generates and transmits an option to join the inter-network facilitation system to the additional client device.

In addition, as used herein, the term referrer client devices include a candidate referrer client device (e.g., a client device that may receive a digital notification). In particular, the term candidate referrer client device refers to a client device for which an intelligent digital content distribution system extracts features and utilizes machine learning to generate a predicted referee interaction metric for selecting a referrer client device tier. Based on the referrer client device tier, an intelligent digital content distribution system can send a digital notification to the candidate referrer client device.

Relatedly, as used herein, the term “referee client device” refers to a computing device (or modeled computing device) associated with a referee (e.g., that receives an invitation or referral from another computing device). For example, a referee client device receives (or is modeled as potentially receiving) an invitation from an additional client device (e.g., a referrer client device) to connect with an inter-network facilitation system. In some cases, a referee client device receives the invitation from another computing device, such as through a digital communication (e.g., an email, text message, or messaging application). In other cases, a referee client device receives the invitation from the inter-network facilitation system based on a user input requesting the inter-network facilitation system to send the invitation to the referee client device.

As used herein, the term “machine learning model” refers to a computer algorithm or a collection of computer algorithms that automatically improve for a particular task through iterative outputs or predictions based on the use of data. For example, a machine learning model can utilize one or more learning techniques to improve accuracy and/or effectiveness. For example, machine learning models include various types of neural networks, decision trees, support vector machines, linear regression models, Bayesian networks, gradient-boosted trees, or random forest models.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., block content elements or content items) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer, each of which performs tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a large language model.

As used herein, the term “referee interaction prediction machine learning model” refers to a machine learning model trained or used to generate predicted referee interaction metrics. In some cases, the referee interaction prediction machine learning model refers to a machine learning model trained or used to utilize referrer client device features to generate metrics indicating a likelihood or probability of an interaction from a referee client device based on features of a referrer client device. For example, the referee interaction prediction machine learning model can utilize a series of decision trees (e.g., random forest model), while in other cases, the referee interaction prediction machine learning model is a series of gradient boosted trees, a multilayer perceptron, a linear regression, a support vector machine, a deep tabular learning architecture, a deep learning transformer (e.g., self-attention-based-tabular transformer), or another machine learning model.

As used herein, the term “predicted referee interaction metrics” refers to a quantitative measure indicating a likelihood, probability, or measure of how a referee client device will respond/interact (e.g., in response to an invitation from a referrer client device). In particular, the term predicted referee interaction metrics indicates how a referee client device will interact/respond after transmission of a digital notification to a referrer client device (e.g., based on features of the referrer client device). In some cases, a predicted referee interaction metric is associated with a measure of a referee client device at a specified future time (e.g., a value contribution at three months or six months). In other cases, a predicted referee interaction metric is associated with an action of the referee client device at a specified future time (e.g., a digital deposit within 45 days of enrollment).

In addition, as used herein, the term “referrer client device tiers” refers to categories, classifications, or groups of referrer client devices (e.g., based on referee interaction metrics corresponding to the referrer client devices). In particular, the term referrer client device tiers refers to ranks, categories, or classifications of predicted referee interaction metrics that indicate potential likelihoods of referee client device interactions corresponding to the referrer client devices. For example, a referrer client device tier includes the grouping of metrics at or between a tier threshold and to which a referrer client device is classified based on the predicted referee interaction metric.

Also, as used herein, the term “optimization model” refers to refers to a computer-implemented model that optimizes or improves a metric/variable by modifying one or more other metrics/variables. In particular, the term optimization model refers to a framework that uses historical patterns and relationships between data to optimize a metric across tiers to improve or optimize a metric (e.g., to achieve a target interaction metric). In some cases, an optimization model adapts output based on target metrics (e.g., target interaction metrics) that can be modified to adjust the selection and weighting of the metrics for the tiers.

Further, as used herein, the term “digital notification distribution policy” refers to a computer-implemented heuristic model to select digital content to distribute to client devices. For example, a digital notification distribution policy can include a plurality of computer-implemented rules for distributing digital notifications to referrer client devices. In particular, a digital notification distribution policy assigns specific values to different tiers (e.g., referrer client device tiers) corresponding to the likelihood that a referee client device associated with the referrer client device will perform certain interactions. For example, a digital notification distribution policy allows for targeted digital notifications, where values, metrics, or other information in the digital notifications are applied consistently and tailored to referrer client devices or referrer client device tiers.

Moreover, as used herein, the term “measured referee client device interactions” refers to observed or historical interactions, communications, or responses from referee client devices (e.g., in response to transmitting a digital notification to referrer client devices). Specifically, measured referee client device interactions refer to data transfers, requests, responses, and other forms of communication between a referee client device and a computing device or system, which are tracked and analyzed based on specific metrics such as speed, frequency, latency, and throughput. For example, measured referee client device interactions include a measure of transfer of currency or tokens from referee client devices to an inter-network facilitation system, a measure of a value that an inter-network facilitation system receives based on interactions of a referee client device with various aspects of the inter-network facilitation system, or whether a referee client device (or user account associated with the referee client device) received a digital direct deposit.

In addition, as used herein, the term “referrer invitation value” refers to a metric or amount included in a digital notification to a referrer client device. Specifically, the term referrer invitation value includes a monetary amount selected for a referrer client device based on a referrer client device tier assigned to the client device and a digital notification distribution policy. In some cases, a referrer invitation value is included in a digital notification as an incentive for referrer client device to send (or invite) another client device (e.g., a referee client device) to try a product, sign up for a service, or join a system.

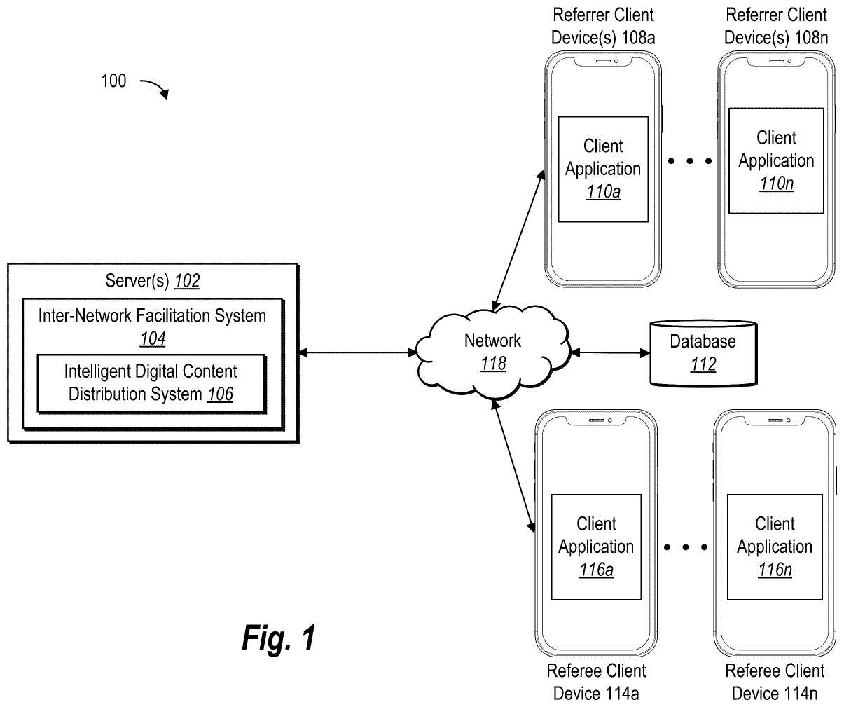

Additional details regarding the intelligent digital content distribution system will now be provided with respect to the figures. For example, FIG. 1 illustrates a block diagram of a system environment for implementing the intelligent digital content distribution system in accordance with one or more embodiments. An overview of the intelligent digital content distribution system is described in relation to FIG. 1. Thereafter, a more detailed description of the components and processes of the intelligent digital content distribution system 102 is provided in relation to the subsequent figures.

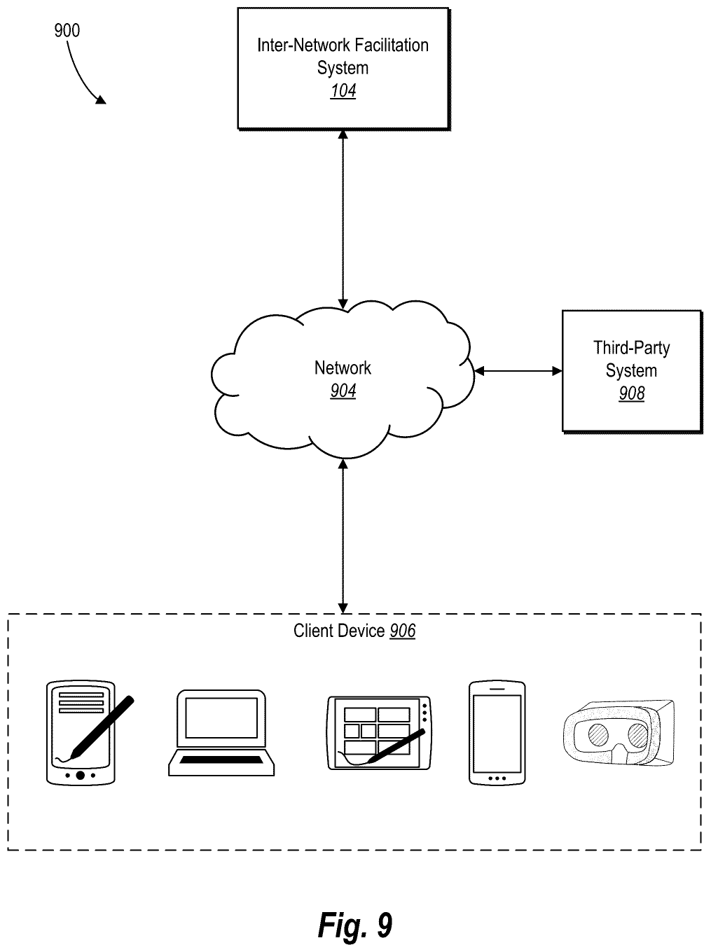

As shown, environment 100 includes server(s) 106, referrer client device(s) 108a-108n, database 112, and referee client device(s) 114a-114n. Each of the components of environment 100 can communicate via network 118, and network 118 may be any suitable network over which computing devices can communicate. Example networks are discussed in more detail in relation to FIGS. 9-9.

As mentioned above, environment 100 includes referrer client device(s) 108a-108n and referee client device(s) 114a-114n. In one or more embodiments, the referrer client device(s) 108a-108n are client devices analyzed by the intelligent digital content distribution system 102 as potential client devices as potential client devices to which to deliver digital notifications. Referee client device(s) 114a-114n are client devices associated with one or more referrer client device(s) 108a-108n and which, in some cases, receive digital notifications from a referrer client device 108a-108n.

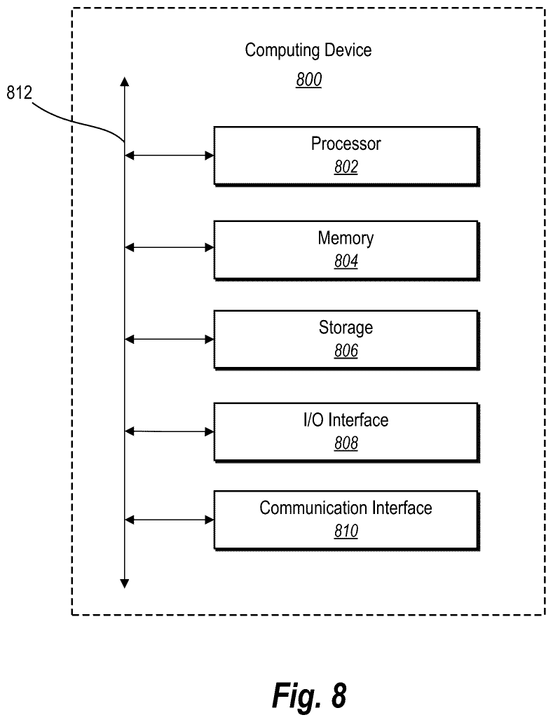

The referrer client device(s) 108a-108n and/or the referee client device(s) 114a-114n can be one of a variety of computing devices, including a smartphone, a tablet, a smart television, a desktop computer, a laptop computer, a virtual reality device, an augmented reality device, or another computing device as described in relation to FIGS. 8-9. The referrer client device(s) 108a-108n and/or the referee client device(s) 114a-114n can communicate with the server(s) 106 via network 118. For example, the referrer client device(s) 108a-108n and/or the referee client device(s) 114a-114n can receive user input from a user interacting with referrer client device(s) 108a-108n and/or referee client device(s) 114a-114n (e.g., via the client application(s) 110a-110n and/or the client application(s) 112a-112n) to, for instance, select user interface elements to interact with the inter-network facilitation system, or to interact with data blocks in a virtual space. In addition, the intelligent digital content distribution system 102 or the server(s) 106 can receive information relating to various interactions with digital notifications and/or user interface elements based on the input received by the referrer client device(s) 108a-108n and/or the referee client device(s) 114a-114n.

As shown, the referrer client device(s) 108a-108n can include a client application 110a-110n, and the referee client device(s) 114a-114n can include a client application 116a-116n. In particular, the client application 110a-110n and/or the client application 116a-116n may be a web application, a native application installed on the referrer client device(s) 108a-108n and/or the referee client device(s) 114a-114n (e.g., a mobile application, a desktop application, etc.), or a cloud-based application where all or part of the functionality is performed by the server(s) 106. Based on instructions from the client application(s) 110a-110n or the client application 116a-116n, the referrer client device(s) 108a-108n and/or the referee client device(s) 114a-114n can present or display information, including a user interface for interacting with interface elements, digital notifications, or other digital content. Using the client application 110a-110n and/or the client application 114a-114n, the referrer client device(s) 108a-108n and/or the referee client device(s) 114a-114n can perform (or request to perform) various operations, such as displaying digital notification, sending data regarding digital notifications or user input to various servers (e.g., server(s) 106), or providing data associated with features of the referrer client device(s) 108a-108n.

As illustrated in FIG. 1, the environment 100 also includes the server(s) 106. The server(s) 106 may generate, track, store, process, receive, and transmit electronic data, such as digital content, digital notifications, results, actions, determinations, responses, computer code, interactions with interface elements, and/or interactions between user accounts or client devices. For example, the server(s) 106 may receive an indication from the referrer client device(s) 108a-108n and/or the referee client device(s) 114a-114n of a user interaction within a digital notification. In addition, the server(s) 106 can transmit data to the referrer client device(s) 108a-108n and/or the referee client device(s) 114a-114n in the form of digital notifications, an instruction interface items or an instruction to render an interface for displaying digital content or digital notifications. Indeed, the server(s) 106 can communicate with the referrer client device(s) 108a-108n and/or the referee client device(s) 114a-114n to send and/or receive data via network 118. In some implementations, the server(s) 106 comprise(s) a distributed server where the server(s) 106 include(s) a number of server devices distributed across the network 118 and located in different physical locations. The server(s) 106 can comprise one or more content servers, application servers, container orchestration servers, communication servers, web-hosting servers, machine learning servers, and other types of servers.

As shown in FIG. 1, the server(s) 106 can also include the intelligent digital content distribution system 102 as part of the inter-network facilitation system 104. The inter-network facilitation system 104 can communicate with the referrer client device(s) 108a-108n and/or the referee client device(s) 114a-114n to perform various functions associated with the client application 108a-108n and/or the client application(s) 114a-114, such as managing user accounts, receiving client device features (e.g., of the referrer client device(s) 108a-108n), or track digital notifications. Indeed, inter-network facilitation system 104 can include a network-based smart cloud storage system to manage, store, and maintain content items and related data across numerous user accounts. In some embodiments, the intelligent digital content distribution system 102 and/or the inter-network facilitation system 104 utilize the database 112 to store and access information such as user account information, digital notification tracking data, and other information.

Although FIG. 1 depicts the intelligent digital content distribution system 102 located on the server(s) 106, in some implementations, the intelligent digital content distribution system 102 may be implemented by (e.g., located entirely or in part on) one or more other components of the environment. For example, the intelligent digital content distribution system 102 may be implemented as part of the referrer client device(s) 108a-108n, the referee client device(s) 114a-114n, and/or a third-party system. As another example, the referrer client device(s) 108a-108n, the referee client device(s) 114a-114n, and/or a third-party system can download all or part of the intelligent digital content distribution system 102 for implementation independent of, or together with, the server(s) 106.

In some implementations, though not illustrated in FIG. 1, environment 100 may have a different arrangement of components and/or may have a different number or set of components altogether. For example, the client device(s) 108a-108n may communicate directly with the intelligent digital content distribution system 102, bypassing network 118. The environment 100 may also include one or more third-party systems, each corresponding to a different data source. In addition, the environment 100 can include the database 112 located external to the server(s) 106 (e.g., in communication via the network 118) or located on the server(s) 106, the referrer client device(s) 108a-108n, and/or the referee client device(s) 114a-114n.

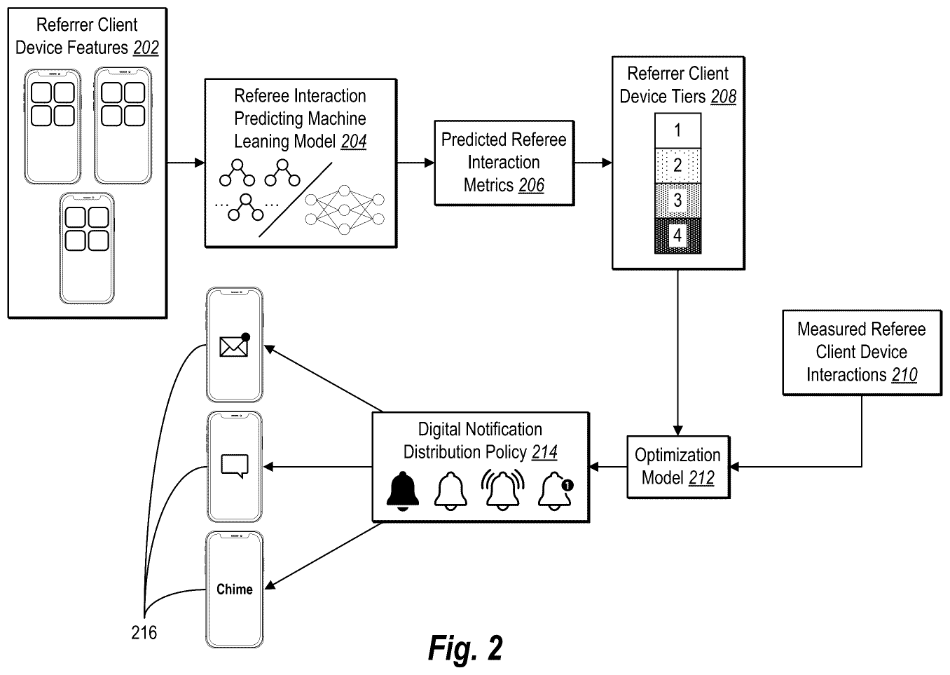

As previously mentioned, the intelligent digital content distribution system 102 generates predicted referee interaction metrics based on features of referrer client devices and generates a digital notification distribution policy for distributing digital notifications to referrer client devices. In particular, the intelligent digital content distribution system 102 utilizes machine learning to generate predicted referee interaction metrics to build tiers of referrer client devices for generating a digital notification distribution policy for transmitting digital content to referrer client devices. FIG. 2 illustrates an example diagram of an overview of the intelligent digital content distribution system 102 utilizing a referee interaction predicting machine learning model and distributing digital notifications in accordance with one or more embodiments. Additional details regarding the various acts and processes introduced in relation to FIG. 2 are provided thereafter, with reference to subsequent figures.

As shown in FIG. 2, the intelligent digital content distribution system 102 extracts referrer client device features 202 from referrer client devices. Specifically, the intelligent digital content distribution system 102 extracts features of referrer client devices associated with the inter-network facilitation system 104 (e.g., to determine client devices as referrer client devices). For instance, the intelligent digital content distribution system 102 extracts features by identifying and processing data from various hardware or software sources that indicate characteristics or attributes representing the state or behavior of a corresponding referrer client device.

In one or more embodiments, the intelligent digital content distribution system 102 extracts features determining the number of accounts and sessions accessed from the same device, IP address, device ID, operating system, device type, or network over the previous one, seven, and/or thirty days. Similarly, the intelligent digital content distribution system 102 can determine changes in personal identifiable information, context data compared to prior sessions (one hour, one day, or one week before), and failed logins from IP addresses. In some embodiments, the intelligent digital content distribution system 102 utilizes the number of historical devices used by a particular user and/or the age of the user's account (e.g., the time since enrollment). In one or more implementations, the intelligent digital content distribution system 102 utilizes various account information corresponding to a referrer client device. For example, the intelligent digital content distribution system 102 can analyze account balance, direct deposit amount and/or frequency (over one or more threshold durations), account duration, number and/or amount of transactions, etc.

In addition, the intelligent digital content distribution system 102 can determine historical features of referrer client devices and compare those historical features with features of a current device (e.g., to generate device comparison features). The intelligent digital content distribution system 102 can determine differences in counts for various features described herein (e.g., IP address, device ID, and other features) over various time windows. In some embodiments, the intelligent digital content distribution system 102 utilizes real-time features (e.g., 1-5 minutes) in extracting and analyzing features.

The intelligent digital content distribution system 102 can also extract features by determining features of a referrer client device at the time of a request. In some embodiments, the intelligent digital content distribution system 102 extracts features by determining device characteristics of a referrer client device, such as the operating system of the client device (e.g., iOS or Android), the model of the client device (e.g., Samsung or iPhone), the model version of the client device, a name of the client device, or the time zone of the client device. In other embodiments, the intelligent digital content distribution system 102 extracts features by determining the IP address of a referrer client device. In other instances, the intelligent digital content distribution system 102 extracts features by determining account features and information about the secure digital account, such as type of account, direct deposit amount/frequency, or location. Furthermore, in some embodiments, the intelligent digital content distribution system 102 extracts features by determining the device ID of a referrer client device.

As shown in FIG. 2, the intelligent digital content distribution system 102 provides the referrer client device features 202 to the referee interaction predicting machine learning model 204 to generate predicted referee interaction metrics 206. For instance, the referee interaction predicting machine learning model 204 is trained to generate predicted referee interaction metrics indicating likelihoods or predictions for interactions of a referee client device based on features of a referrer client device. Thus, the referee interaction predicting machine learning model 204 can intelligently and accurately predict downstream (or future) interaction of a referee client device based on features of a referrer client device.

In one or more embodiments, the referee interaction predicting machine learning model 204 works together (or collaborates) with additional referee interaction predicting machine learning models. Specifically, the referee interaction predicting machine learning model 204 and the additional referee interaction prediction machine learning models are trained to generate various different predicted referee interaction metrics 206 that indicate probabilities or likelihoods for different referee interactions. For example, the referee interaction predicting machine learning model 204 can generate a predicted referee interaction metric indicating a downstream interaction of a referee client device corresponding to a time threshold, while an additional referee interaction predicting machine learning model can generate a predicted referee interaction metric corresponding to an additional time threshold. As another example, the referee interaction predicting machine learning model 204 can predict a first type of predicted referee interaction metric while an additional referee interaction predicting machine learning model can predict a second type of predicted referee interaction metric.

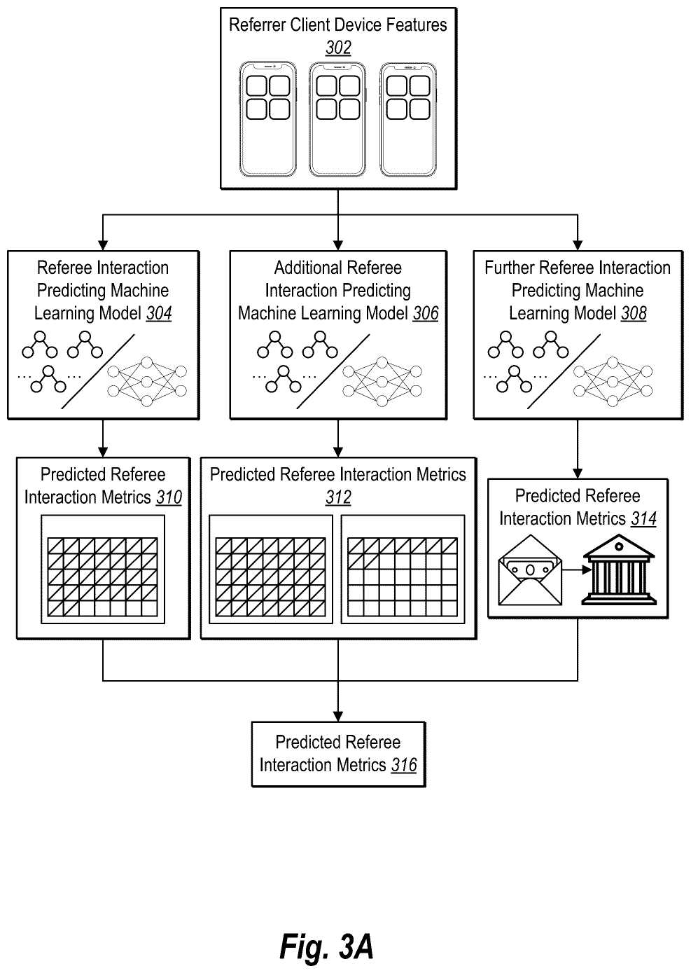

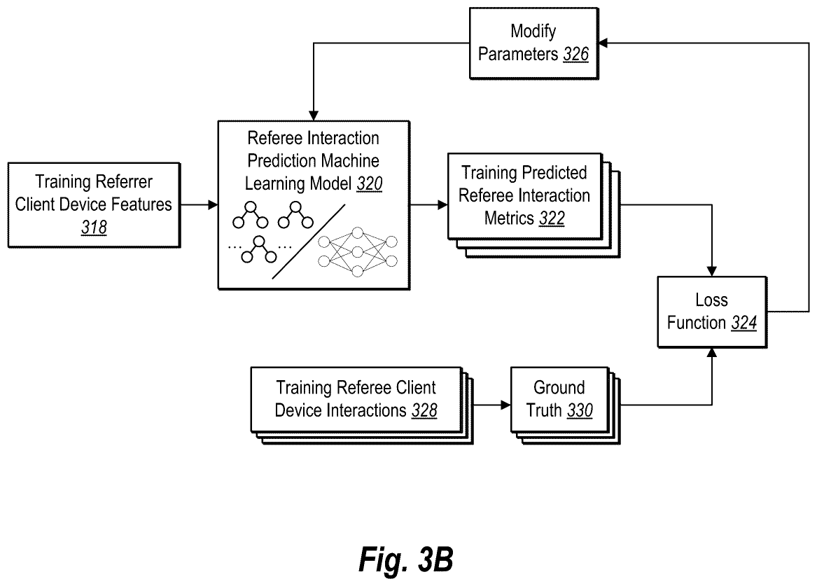

In some embodiments, the predicted referee interaction metrics 206 are one or more combined metrics from various predicted referee interaction metrics generated by the referee interaction predicting machine learning model 204 and additional referee interaction predicting machine learning models. The intelligent digital content distribution system 102 combines, weights, or aggregates predicted referee interaction metrics 206 from various trained referee interaction predicting machine learning models to generate a predicted referee interaction metric for a referrer client device. Additional details regarding the intelligent digital content distribution system 102 utilizing and training a referee interaction predicting machine learning model and additional referee interaction prediction machine learning models are provided below with respect to FIGS. 3A-3B.

As shown in FIG. 2, the intelligent digital content distribution system 102 generates referrer client device tiers 208. In particular, the intelligent digital content distribution system 102 generates a ranked order of the predicted referee interaction metrics 206 and identifies tier thresholds of predicted referee interaction metric values that define the boundaries between referrer client device tiers 208. The intelligent digital content distribution system 102 can assign additional predicted referee interaction metrics (e.g., predicted referee interaction metrics generated after generating the referrer client device tiers) to referrer client device tiers based on comparing the additional predicted referee interaction metrics to the tier thresholds.

As also shown in FIG. 2, the intelligent digital content distribution system 102 utilizes an optimization model 212 to generate a digital notification policy 214. In one or more embodiments, the digital notification policy 214 constitutes referrer invitation values generated or assigned for tiers of the referrer client device tiers 208 based on measured referee client device interactions 210. For example, the intelligent digital content distribution system 102 utilizes the optimization model to analyze referrer invitation values for the referrer client device tiers 208 to analyze different referrer invitation values for referrer client devices based on the measured referee client device interactions 210.

In one or more embodiments, the intelligent digital content distribution system 102 also generates the digital notification policy 214 to satisfy a target interaction metric. For example, the intelligent digital content distribution system 102 receives a user interaction at an administrator device indicating a target interaction metric, and the optimization model 212 analyzes referrer invitation values across the referrer client device tiers 208 and compared to the measured referee client device interactions to model a combination of referrer invitation values that are predicted to result in the target interaction metric. The optimization model 212 assigns the combination of referrer invitation values to the corresponding tier of the referrer client device tiers 208 to generate the digital notification policy 214.

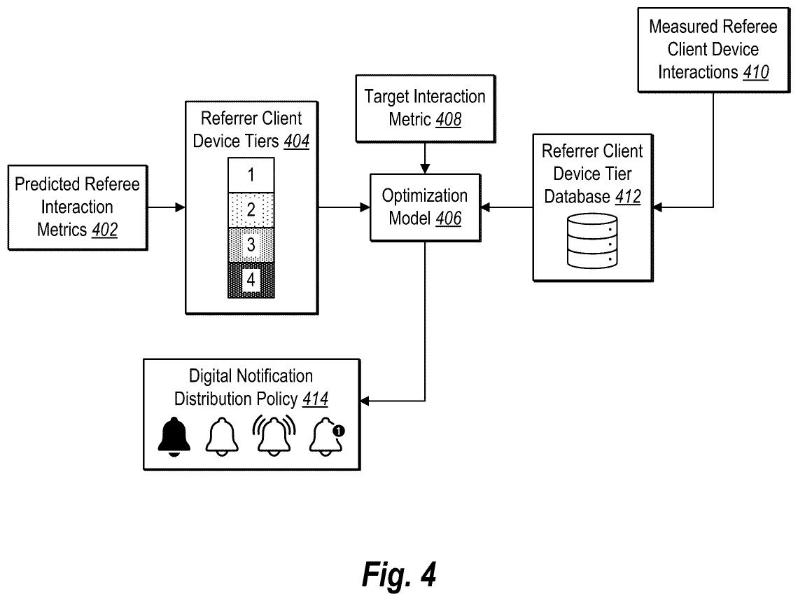

As just mentioned, the optimization model 212 utilizes measured referee client device interactions 210 to generate the digital notification policy 214. In particular, the intelligent digital content distribution system 102 aggregates the measured referee client device interactions 210 according to the referrer client device tiers 208 to generate a referrer client device tier database. In some cases, the intelligent digital content distribution system 102 receives (or accesses) measured referee client device interactions that are measured from historical referee client devices that responded to digital notifications with corresponding referral invitation values. Additional details regarding the intelligent digital content distribution system 102 generating a referrer client device database and utilizing an optimization model are provided with respect to FIG. 4 below.

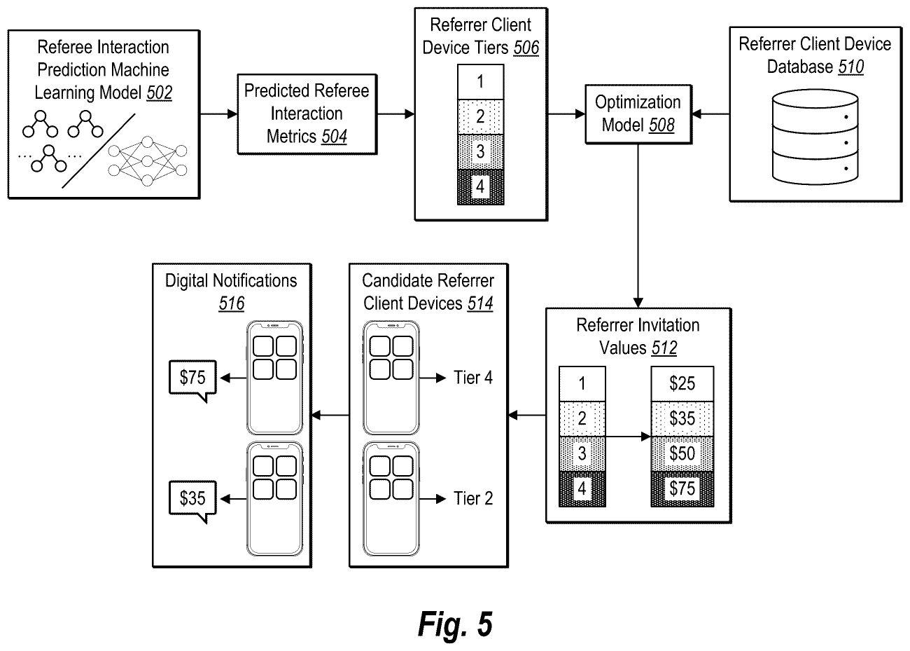

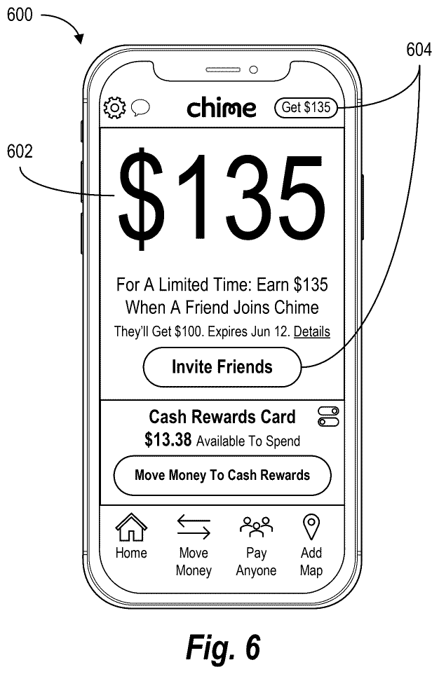

As shown in FIG. 2, the intelligent digital content distribution system 102 transmits digital notifications 216 to referrer client devices. In particular, the intelligent digital content distribution system 102 generates digital notifications 216 for referrer client devices, where a digital notification includes an indication of a referrer invitation value corresponding to a tier of the referrer client device tiers 208 for the referrer client device. For example, the intelligent digital content distribution system 102 can generate a predicted referee interaction metric for a candidate referrer client device and identify a referral client device tier corresponding to the predicted referee interaction metric, then transmit a digital notification to the candidate referrer client device with a referrer invitation value corresponding to the referral client device tier. Additional details regarding the intelligent digital content distribution system 102 generating and transmitting digital notifications according to a digital notification policy are provided below with respect to FIG. 5 and FIG. 6.

As previously mentioned, the intelligent digital content distribution system 102 utilizes one or more referee interaction predicting machine learning models to generate predicted referee metrics. FIGS. 3A-3B illustrate an example sequence flow of an intelligent digital content distribution system utilizing and training a referee interaction predicting machine learning model to generate predicted referee interaction metrics in accordance with one or more embodiments. In particular, FIG. 3A illustrates the intelligent digital content distribution system 102 utilizing a referee interaction prediction machine learning model and one or more additional referee interaction prediction machine learning models to generate various predicted referee interaction metrics. FIG. 3B illustrates training the referee interaction prediction machine learning model or an additional referee interaction prediction machine learning model.

As shown in FIG. 3A, the intelligent digital content distribution system 102 provides referrer client device features 302 to referee interaction predicting machine learning model 304, additional referee interaction predicting machine learning model 306, and further referee interaction predicting machine learning model 308. In one or more embodiments, referee interaction predicting machine learning model 304, additional referee interaction predicting machine learning model 306, and further referee interaction predicting machine learning model 308 are trained to generate a different predicted referee interaction metric corresponding to an interaction type.

For example, as shown, the referee interaction predicting machine learning model 304 generates predicted referee interaction metrics 310. For instance, the referee interaction predicting machine learning model 304 is trained to generate a predicted referee interaction metric indicating a likelihood or metric for a referee client device interactions corresponding to a first time threshold. In some cases, the predicted referee interaction metrics 310 indicate a total contribution value of a referee client device within a first time threshold (e.g., three months) based on features of a referrer client device associated with the referee client device. Similarly, in some embodiments, the predicted referee interaction metrics 310 can include a prediction of referee client devices that initiate a direct deposit within 30 days of initiating enrollment procedures (if enrolled within 30 days of transmission of a digital notification to the referrer client device).

As also shown, the additional referee interaction predicting machine learning model 306 generates predicted referee interaction metrics 312. For example, the additional referee interaction predicting machine learning model is trained to generate a predicted referee interaction metric indicating a likelihood or metric for a referee client device interaction corresponding to a second time threshold. In some cases, the predicted referee interaction metrics 312 indicate a total contribution value of a referee client device within a second time threshold (e.g., six months) based on features of a referrer client device associated with the referee client device. For instance, the predicted referee interaction metrics 312 can include a prediction of referee client devices that initiate a direct deposit within 60 days of enrollment. In some implementations, the predicted referee interaction metrics 312 include a different type or class of prediction. For example, the predicted referee interaction metrics 312 can include a prediction of referee client devices that initiate enrollment procedures within 30 days of transmitting a digital notification of the referrer client device.

In addition, as shown, the further referee interaction predicting machine learning model 308 generates predicted referee interaction metrics 314. For instance, the further referee interaction predicting machine learning model generates predicted referee interaction metrics 314 indicating a likelihood or metric for a referee client device interaction corresponding to a third time threshold. In some cases, the predicted referee interaction metrics 314 indicate a likelihood that a referee client device will have a qualifying digital deposit within a third time threshold (e.g., 45 days) based on features of a referrer client device associated with the referee client device. In some embodiments, the predicted referee interaction metrics 314 can include a third type of classification. For instance, the predicted referee interaction metrics 314 can include a prediction of a total value of referee client devices over a certain period of time after transmission of a digital notification to a referrer client device.

As shown, in one or more embodiments, the intelligent digital content distribution system 102 generates predicted referee interaction metrics 316 from predicted referee interaction metrics 310, predicted referee interaction metrics 312, and predicted referee interaction metrics 314. In particular, the intelligent digital content distribution system 102 aggregates or weights predicted referee interaction metrics 310, predicted referee interaction metrics 312, and predicted referee interaction metrics 314 to generate predicted referee interaction metrics 316. For example, the intelligent digital content distribution system 102 can utilize a weighted average, a geometric mean, a harmonic mean, a min-max normalization and averaging, a multi-objective optimization, a custom function, a logarithmic weighted sum, voting or ranking, or a weighted maximum to generate the predicted referee interaction metrics 316.

As previously mentioned, the intelligent digital content distribution system 102 trains the referee interaction predicting machine learning model to generate predicted referee interaction metrics. FIG. 3B illustrates training the referee interaction predicting machine learning model to generate accurate predicted referee interaction metrics. Though only the referee interaction predicting machine learning model is depicted in FIG. 3B, it is understood that the iterative training process may also be performed for any of the models described above.

As illustrated in FIG. 3B, the intelligent digital content distribution system 102 accesses training referee client device interactions 328. Training referee client device interactions 328 constitute referee client device interactions downstream (e.g., in the future) from receiving a digital notification or invitation from a referrer client device. The training referee client device interactions 328 have a corresponding ground truth 330, where the ground truth 330 indicates actual referee client device interactions (e.g., measured historical interactions). Accordingly, in some cases, the intelligent digital content distribution system 102 treats the ground truth 330 as a ground truth measurement for training the referee interaction prediction machine learning model 320.

As further illustrated in FIG. 3B, the intelligent digital content distribution system 102 provides training referrer client device features 318 associated with the training referee client device interactions to the referee interaction predicting machine learning model to generate training predicted referee interaction metrics 322 based on the training referee client device features 318. As the name indicates, the training referrer client device features represent features associated with the training referee client device interactions that are used for training the referee interaction prediction machine learning model 320. Accordingly, the training referrer client device features can constitute features used as input for the referee interaction prediction machine learning model 320.

In one or more embodiments, the intelligent digital content distribution system 102 uses downstream interactions of the referee client devices as additional ground truth measures for training the referee interaction prediction machine learning model 320. In particular, after the intelligent digital content distribution system 102 sends a digital notification to a referrer client device, the intelligent digital content distribution system 102 monitors the digital notification and measures downstream referee interactions to use training data for the referee interaction prediction machine learning model 320. Indeed, by receiving measured interactions, the referee interaction prediction machine learning model 320 continuously learns and updates to generate accurate predicted referee interaction metrics.

In addition, as illustrated in FIG. 3B, the intelligent digital content distribution system 102 utilizes a loss function to compare the training predicted referee interaction metrics 322 to the ground truth 330 (e.g., to determine an error or a measure of loss between them). For instance, in cases where the referee interaction prediction machine learning model 320 is an ensemble of gradient-boosted trees, the intelligent digital content distribution system 102 utilizes a mean squared error loss function (e.g., for regression) and/or a logarithmic loss function (e.g., for classification) as the loss function 324. By contrast, in embodiments where the referee interaction prediction machine learning model 320 is a neural network, the intelligent digital content distribution system 102 can utilize a cross-entropy loss function, an L1 loss function, or a mean squared error loss function as the loss function 324. For example, the intelligent digital content distribution system 102 utilizes the loss function 324 to determine a difference between the training predicted referee interaction metrics and the ground truth 330.

As further illustrated in FIG. 3B, the intelligent digital content distribution system modifies parameters 326. In particular, the intelligent digital content distribution system 102 fits the referee interaction prediction machine learning model 320 based on loss from the loss function 324. For instance, the intelligent digital content distribution system 102 performs modifications or adjustments to the referee interaction prediction machine learning model 320 to reduce the measure of loss from the loss function 324 for a subsequent training iteration. (e.g., utilizing back propagation and/or gradient descent).

For gradient-boosted trees, for example, the intelligent digital content distribution system 102 trains the referee interaction prediction machine learning model 320 on the gradients of errors determined by the loss function 324. For instance, the intelligent digital content distribution system solves a convex optimization problem (e.g., of infinite dimensions) while regularizing the objective to avoid overfitting. In certain implementations, the intelligent digital content distribution system 102 scales the gradients to emphasize corrections to under-represented classes.

In some embodiments, the intelligent digital content distribution system 102 adds a new weak learner (e.g., a new boosted tree) to the referee interaction prediction machine learning model 320 for each successive training iteration as part of solving the optimization problem. For example, the intelligent digital content distribution system 102 finds a feature that minimizes a loss from the loss function 324 and either adds the feature to the current iteration's tree or starts to build a new tree with the feature. In addition to, or in the alternative, gradient-boosted decision trees, the intelligent digital content distribution system 102 trains a logistic regression to learn parameters for generating one or more predicted referee interaction metrics, such as a total contribution value metric or a digital deposit likelihood. To avoid overfitting, the intelligent digital content distribution system 102 further regularizes based on hyperparameters such as the learning rate, stochastic gradient boosting, the number of trees, the tree depth(s), complexity penalization, and L1/L2 regularization.

In embodiments where the referee interaction prediction machine learning model 320 is a neural network, the intelligent digital content distribution system 102 modifies parameters 326 by modifying internal parameters (e.g., weights) of the referee interaction prediction machine learning model 320 to reduce the measure of loss for the loss function 324. Indeed, the intelligent digital content distribution system 102 modifies how the referee interaction prediction machine learning model 320 analyzes and passes data between layers and neurons by modifying the internal network parameters. Thus, over multiple iterations, the intelligent digital content distribution system 102 improves the accuracy of the referee interaction prediction machine learning model 320.

Indeed, in some cases, the intelligent digital content distribution system 102 repeats the training process illustrated in FIG. 3B for multiple iterations. For example, the intelligent digital content distribution system 102 repeats the iterative training by selecting a new set of training referrer client device features for each training referee client device interaction along with a corresponding ground truth. The intelligent digital content distribution system 102 further generates a new set of training predicted referee interaction metrics for each iteration. As described above, the intelligent digital content distribution system 102 also compares a training predicted referee interaction metric at each iteration with the corresponding ground truth and further modifies parameters. The intelligent digital content distribution system 102 repeats this process until the referee interaction prediction machine learning model 320 generates training predicted referee interaction metrics that result in predicted referee interaction metrics that satisfy a threshold measure of loss.

As previously mentioned, the intelligent digital content distribution system 102 utilizes an optimization model to generate a digital notification distribution policy. In particular, the intelligent digital content distribution system 102 generates a referrer client device tier database that the optimization model utilizes to generate the digital notification distribution policy. FIG. 4 illustrates an example sequence flow of an intelligent digital content distribution system utilizing an optimization model in accordance with one or more embodiments.

As illustrated in FIG. 4, the intelligent digital content distribution system 102 utilizes predicted referee interaction metrics 402 to generate referrer client device tiers 404. In particular, the intelligent digital content distribution system 102 generates referrer client device tiers 404 by generating a ranked order of the predicted referee interaction metrics, then identifies tier thresholds defining tiers of predicted referee interaction metrics. For example, the intelligent digital content distribution system 102 defines tier thresholds based on the predicted referrer interaction metrics, such as by identifying the number of predicted referee interaction metrics and selecting predicted referrer interaction metrics for the tier threshold. After defining tier thresholds, the intelligent digital content distribution system 102 assigns predicted referrer interaction metrics to tiers based on whether they satisfy (e.g., fall above or below) the tier thresholds. To illustrate, the intelligent digital content distribution system 102 defines predicted referee interaction metrics at or above 90 as tier one, metrics with a score of 80 and 89 as tier two, metrics with a score between 70 and 79 as tier three, and so on.

As also shown in FIG. 4, the intelligent digital content distribution system 102 identifies a target interaction metric 408. In one or more embodiments, the target interaction metric 408 is a metric received or identified from a user interaction of an administrator client device that indicates a target contribution value metric for client devices of the inter-network facilitation system. In some cases, the target interaction metric 408 is a combined metric that incorporates a lifetime value metric (e.g., value of a referrer client device) and an acquisition value metric (e.g., expense to enroll a referrer client device), such as by generating a ratio of the lifetime value metric and the acquisition value metric (e.g., by dividing the lifetime value metric by the acquisition value metric).

In one or more embodiments, the optimization model 406 generates the digital notification distribution policy from a referrer client device tier database 412, the target interaction metric 408, and the referrer client device tiers 404. For example, the intelligent digital content distribution system 102 identifies the target interaction metric 408 and utilizes the optimization model 406 to analyze different referrer invitation values across referrer client device tiers 404 to model a combination of referrer invitation values that are predicted to result in the target interaction metric. The intelligent digital content distribution system 102 assigns referrer invitation values from the combination of referrer invitation values to tiers of the referrer client device tiers 404, then generates the digital notification policy 414.

In some embodiments, the intelligent digital content distribution system 102 generates the referrer client device tier database 412 from measured referee client device interactions 410. In particular, the intelligent digital content distribution system 102 aggregates the measured referee client device interactions 410 according to the referrer client device tiers 404 to generate the referrer client device tier database 412. For example, the intelligent digital content distribution system 102 organizes or categorizes the measured referee client device interactions 410 into tiers based on the tier thresholds of the referrer client device tiers 404 to generate the referrer client device tier database 412.

In one or more embodiments, the intelligent digital content distribution system 102 generates the measured referee client device interactions 410. In particular, the intelligent digital content distribution system 102 transmits referrer invitation values to historical referrer client devices in order to measure interactions of historical referee client devices associated with the historical referrer client devices that received the referrer invitation value. For example, the intelligent digital content distribution system 102 sends digital notifications comparing randomly selected referrer invitation values randomly and measure downstream interactions of referee client devices. To illustrate, the intelligent digital content distribution system 102 sends digital notifications with one of five referrer invitation values (e.g., $100, $125, $135, $150, $175) and measures downstream referee client device interactions.

As mentioned, the intelligent digital content distribution system 102 measures referee client device interactions that are associated with the client devices that received the referrer invitation values. For example, the intelligent digital content distribution system 102 measures one or more metrics of downstream interactions of historical referee client devices. To illustrate, the intelligent digital content distribution system 102 measures total contribution values of historical referee client devices within varying time thresholds (e.g., three months or six months) or whether the historical referee client devices had a qualifying digital deposit within a time threshold (e.g., 45 days).

For example, the intelligent digital content distribution system 102 can determine a database of lifetime value metrics, acquisition value metrics, lifetime value-acquisition ratios, and/or other interaction metrics for different tiers (and different referrer invitation values). The intelligent digital content distribution system 102 can identify a target interaction metric (e.g., a certain return value a number of referrer client devices that will enroll or initiate direct deposits for example). The intelligent digital content distribution system 102 can then model different referrer invitation values across the different tiers. Given the referrer client device database 510, the optimization model can determine a predicted interaction metric resulting from a particular combination of referrer invitation values. Thus, the intelligent digital content distribution system 102 can modify the referrer invitation values until identifying a combination of values across different referrer client device tiers that will result in the target interaction metric. In this manner, the intelligent digital content distribution system 102 can generate a digital notification distribution policy indicating referrer invitation values for referrer client devices corresponding to different tiers.

As previously mentioned, the intelligent digital content distribution system 102 generates a digital notification distribution policy. In particular, the intelligent digital content distribution system 102 transmits digital notifications with referrer invitation values according to the digital notification distribution policy. FIG. 5 illustrates an example sequence flow of an intelligent digital content distribution system transmitting digital notifications in accordance with a digital notification distribution policy in accordance with one or more embodiments.

As shown in FIG. 5 and as previously described, the intelligent digital content distribution system 102 utilizes a referee interaction prediction machine learning model 502 to generate predicted referee interaction metrics 504 and then generates referrer client device tiers 506. The intelligent digital content distribution system 102 then utilizes an optimization model to generate referrer invitation values 512 based on comparing the referrer client device database 510 to generate the digital notification policy of referrer invitation values 512 that correspond to tiers of the referrer client device tiers. In particular, the optimization model 508 assigns or selects a referrer invitation value for tiers of the referrer invitation values 512. For example, as shown, the optimization model assigns a referrer invitation value of $25 for tier one, a referrer invitation value of $35 for tier two, a referrer invitation value of $50 for tier three, and a referrer invitation value of $75 for tier four.

In one or more embodiments, the intelligent digital content distribution system 102 assigns tiers for candidate referrer client devices 514. For example, the intelligent digital content distribution system 102 extracts features of candidate referrer client devices and utilizes the referee interaction prediction machine learning model to generate predicted referee interaction metrics and selects a tier for candidate referrer client devices according to the referrer client device tiers 506. In some cases, the intelligent digital content distribution system 102 assigns a tier to the candidate referrer client devices based on comparing predicted referee interaction metrics to tier thresholds for the referrer client device tiers 506.

For example, for a new candidate referrer client device, the intelligent digital content distribution system 102 can extract referrer client device features, analyze these features utilizing the referee interaction prediction machine learning model, and generate a predicted referee interaction metric (e.g., 85). The intelligent digital content distribution system 102 can compare the predicted referee interaction metric (e.g., 85) to referrer client device tier thresholds to determine a referrer client device tier (e.g., 85 falls between 80 and 90, leading to a tier of 2). Based on the referrer client device tier, the intelligent digital content distribution system 102 can then select a referrer invitation value corresponding to the referrer client device tier (e.g., the digital notification distribution policy indicates that tier 2 corresponds to a $35 referrer invitation value).

Based on the tiers assigned to the candidate referrer client devices 514, the intelligent digital content distribution system 102 generates digital notifications 516 for the candidate referrer client devices 514 that include an indication of a referral invitation value that corresponds to the tier for the candidate referrer client device. For instance, the intelligent digital content distribution system 102 can provide a digital notification with an indication of a referral invitation value of $75 for a candidate referrer client device assigned tier fo9ur a digital notification with an indication of a referral invitation value of $35 for a candidate referrer client device assigned tier two.

In one or more embodiments, the intelligent digital content distribution system 102 transmits digital notifications to a selected candidate referrer client device. For example, the intelligent digital content distribution system 102 can transmit digital notifications to candidate referrer client devices assigned to selected tiers of the referrer client device tiers. To illustrate, the intelligent digital content distribution system 102 transmits digital notifications to candidate referrer client devices assigned to tier three or tier four and does not transmit digital notifications to candidate referrer client devices belonging to other tiers (e.g., higher or lower tiers).

In addition, in some embodiments, the intelligent digital content distribution system 102 does not assign candidate referrer client devices to a referrer client device tier. Specifically, the intelligent digital content distribution system 102 provides client device features to the referee interaction prediction machine learning model 502 to generate a predicted referee interaction metric but determines that the predicted referee interaction metric does not satisfy any tier thresholds for the referrer client device tiers. In some instances, the intelligent digital content distribution system 102 assigns candidate referrer client devices that do not satisfy tier thresholds to a tier that will not receive digital notifications (e.g., tier one).

As just mentioned, the intelligent digital content distribution system 102 sends digital notifications to referrer client devices. In particular, the intelligent digital content distribution system 102 transmits digital notifications that comprise an indication of a referrer invitation value corresponding to the referrer client device tier for the referrer client device. FIG. 6 illustrates an example graphical user interface of the intelligent digital content distribution system sending a digital notification that includes a referrer invitation value in accordance with one or more embodiments.

As shown in FIG. 6, the intelligent digital content distribution system 102 sends digital notification 602 to referrer client device 600. In particular, the intelligent digital content distribution system 102 digital notification 602 includes an indication of a referrer invitation value corresponding to the referrer client device tier for the referrer client device 600. In some cases, the intelligent digital content distribution system 102 maintains digital notifications and adds indications of the referrer invitation value corresponding to the referrer client device tier of the referrer client device.

As also shown in FIG. 6, the digital notification comprises options 604 to accept the digital notification. In particular, a user selection of an option of options 604 sends a digital notification comprising an invitation for a referee client device. For example, based on receiving a user selection from the referrer client device of one of the options 604, the intelligent digital content distribution system 102 provides options for the referrer client device to provide user input for the referee client device (e.g., email, phone number, other contact information) for the intelligent digital content distribution system 102 to transmit a digital notification to the referee client device. If (upon selection of options 604 and transmission of the digital notification to the referee client device) the referee client device enrolls, the intelligent digital content distribution system 102 can provide or transmit the referrer invitation value to an account corresponding to the referrer client device.

In one or more embodiments, the intelligent digital content distribution system 102 includes a referral invitation value for a referee client device. For instance, in some cases, the intelligent digital content distribution system 102 assigns the same tier for the referee client device and provides an indication of the same referral invitation value for a digital notification to the referee client device. In other cases, the intelligent digital content distribution system 102 generates an additional referral invitation value specific to the referee client device. For example, the intelligent digital content distribution system 102 can generate a referral invitation value for the referee client device based on the association of the referee client device to the referrer client device.

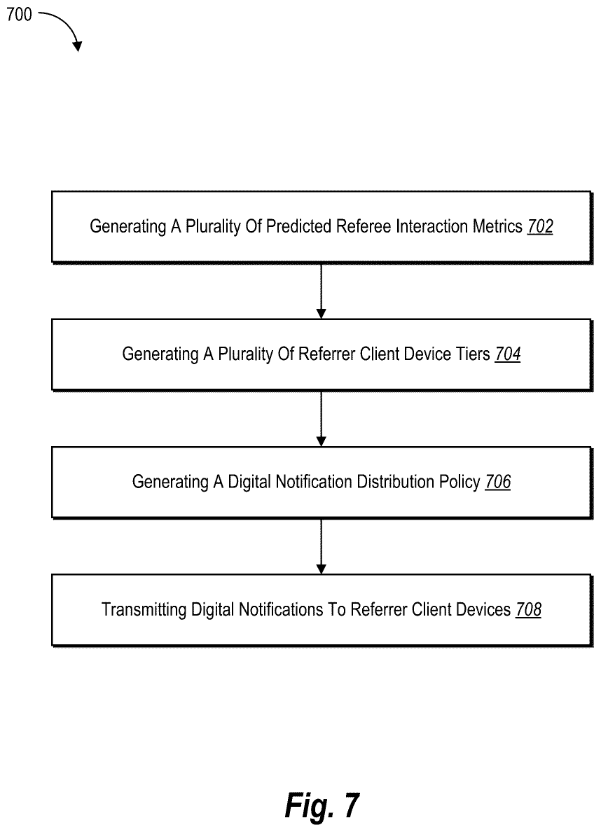

FIGS. 1-6, the corresponding text, and the examples provide a number of different methods, systems, devices, and non-transitory computer-readable media of the intelligent digital content distribution system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for utilizing machine learning models to generate predicted referee interaction metrics for downstream referee client devices and generating a digital notification policy for transmitting digital notifications to corresponding referrer client devices in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. ______. In some embodiments, a system can perform the acts of FIG. 7.

As shown in FIG. 7, the series of acts 700 includes an act 702 of generating a plurality of predicted referee interaction metrics, an act 704 of generating a plurality of referrer client device tiers, an act 706 of generating a digital notification distribution policy, and an act 708 of transmitting digital notifications to referrer client devices.

In particular, the act 702 can include generating, utilizing a trained referee interaction prediction machine learning model, a plurality of predicted referee interaction metrics from a plurality of referrer client device features, the act 704 can include generating a plurality of referrer client device tiers based on the plurality of predicted referee interaction metrics, the act 706 can include generating, utilizing an optimization model, a digital notification distribution policy for the plurality of referrer client device tiers from a set of measured referee client device interactions for the plurality of referrer client device tiers and a target interaction metric, and the act 708 can include transmitting digital notifications to referrer client devices in accordance with the digital notification distribution policy and the plurality of referrer client device tiers.

For example, in one or more embodiments, the series of acts 700 includes wherein generating the plurality of predicted referee interaction metrics comprises generating, utilizing the trained referee interaction prediction machine learning model, a first plurality of predicted referee interaction metrics; and generating, utilizing an additional trained referee interaction prediction machine learning model, a second plurality of predicted referee interaction metrics.

In addition, in one or more embodiments, the series of acts 700 includes generating the plurality of predicted referee interaction metrics by combining the first plurality of predicted referee interaction metrics from the trained referee interaction prediction machine learning model and the second plurality of predicted referee interaction metrics from the additional trained referee interaction prediction machine learning model.

Also, in one or more embodiments, the series of acts 700 includes wherein generating the plurality of referrer client device tiers based on the plurality of predicted referee interaction metrics comprises generating a ranked order of the plurality of predicted referee interaction metrics and identifying tier thresholds based on the ranked order of the plurality of predicted referee interaction metrics.

Further, in one or more embodiments, the series of acts 700 includes generating a referrer client device tier database by aggregating measured referee client device interactions from the set of measured referee client device interactions according to the plurality of referrer client device tiers and referrer invitation values transmitted to historical referrer client devices corresponding to the measured referee client device interactions; and generating, utilizing the optimization model, referrer invitation values corresponding to the plurality of referrer client device tiers based on the referrer client device tier database.

Moreover, in one or more embodiments, the series of acts 700 includes wherein transmitting the digital notifications comprises extracting client device features for a candidate referrer client device; and generating, utilizing the trained referee interaction prediction machine learning model, a predicted referee interaction metric for the candidate referrer client device from the client device features. In addition, in one or more embodiments, the series of acts 700 includes transmitting the digital notifications comprises: selecting a referrer client device tier for the candidate referrer client device from the plurality of referrer client device tiers based on the predicted referee interaction metric for the candidate referrer client device; and transmitting to the candidate referrer client device a digital notification comprising a referrer invitation value according to the digital notification distribution policy and the referrer client device tier.

In addition, in one or more embodiments, the series of acts 700 includes generating the set of measured referee client device interactions for the plurality of referrer client device tiers by providing a set of digital notifications comprising referrer invitation values to a plurality of test referrer client devices; and measuring interactions of referee client devices associated with test referrer client devices of the plurality of test referrer client devices.

Also, in one or more embodiments, the series of acts 700 includes training the trained referee interaction prediction machine learning model utilizing historical referrer client device features and a set of training referee client device interactions.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., computing device 800, server(s) 106, referrer client device(s) 108a-108n, and referral client devices 112a-112n). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

FIG. 9 illustrates an example network environment 900 of the inter-network facilitation system 104. The network environment 900 includes a client device 906 (e.g., referrer client device(s) 108a-108n, referee client device(s) 114a-114n), an inter-network facilitation system 104, and a third-party system 908 connected to each other by a network 904. Although FIG. 9 illustrates a particular arrangement of the client device 906, the inter-network facilitation system 104, the third-party system 908, and the network 904, this disclosure contemplates any suitable arrangement of client device 906, the inter-network facilitation system 104, the third-party system 908, and the network 904. As an example, and not by way of limitation, two or more of client device 906, the inter-network facilitation system 104, and the third-party system 908 communicate directly, bypassing network 904. As another example, two or more of client device 906, the inter-network facilitation system 104, and the third-party system 908 may be physically or logically co-located with each other in whole or in part.

Moreover, although FIG. 9 illustrates a particular number of client devices 906, inter-network facilitation system 104, third-party systems 908, and networks 904, this disclosure contemplates any suitable number of client devices 906, FIG. 9, third-party systems 908, and networks 904. As an example, and not by way of limitation, network environment 900 may include multiple client devices 906, inter-network facilitation system 104, third-party systems 908, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906, inter-network facilitation system 104 (e.g., which hosts the intelligent digital content distribution system 102), and third-party system 908 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 7. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party-system 908. For example, the inter-network facilitation system 104 may receive authentication credentials from a user to link a third-party system 908 such as an online bank account, credit account, debit account, or other financial account to a user account within the inter-network facilitation system 104. The inter-network facilitation system 104 can subsequently communicate with the third-party system 908 to detect or identify balances, transactions, withdrawal, transfers, deposits, credits, debits, or other transaction types associated with the third-party system 908. The inter-network facilitation system 104 can further provide the aforementioned or other financial information associated with the third-party system 908 for display via the client device 906. In some cases, the inter-network facilitation system 104 links more than one third-party system 908, receiving account information for accounts associated with each respective third-party system 908 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 908 and linked to a user account within the inter-network facilitation system 104. Indeed, the inter-network facilitation system 104 can facilitate access to, and transactions to and from, the bank account of the third-party system 908 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) across accounts of different third-party systems 908, and to present corresponding information via the client device 906.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 908), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 904.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 908 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 908 can communicate with the inter-network facilitation system 104 to provide financial information pertaining to balances, transactions, and other information, whereupon the inter-network facilitation system 104 can provide corresponding information for display via the client device 906. In particular embodiments, a third-party system 908 communicates with the inter-network facilitation system 104 to update account balances, transaction histories, credit usage, and other internal information of the inter-network facilitation system 104 and/or the third-party system 908 based on user interaction with the inter-network facilitation system 104 (e.g., via the client device 906). Indeed, the inter-network facilitation system 104 can synchronize information across one or more third-party systems 908 to reflect accurate account information (e.g., balances, transactions, etc.) across one or more networked systems, including instances where a transaction (e.g., a transfer) from one third-party system 908 affects another third-party system 908.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a trained referee interaction prediction machine learning model, a plurality of predicted referee interaction metrics from a plurality of referrer client device features;
generating a plurality of referrer client device tiers based on the plurality of predicted referee interaction metrics;
generating, utilizing an optimization model, a digital notification distribution policy for the plurality of referrer client device tiers from a set of measured referee client device interactions for the plurality of referrer client device tiers and a target interaction metric; and
transmitting digital notifications to referrer client devices in accordance with the digital notification distribution policy and the plurality of referrer client device tiers.

2. The computer-implemented method of claim 1, wherein generating the plurality of predicted referee interaction metrics comprises:
generating, utilizing the trained referee interaction prediction machine learning model, a first plurality of predicted referee interaction metrics; and
generating, utilizing an additional trained referee interaction prediction machine learning model, a second plurality of predicted referee interaction metrics.

3. The computer-implemented method of claim 2, further comprising generating the plurality of predicted referee interaction metrics by combining the first plurality of predicted referee interaction metrics from the trained referee interaction prediction machine learning model and the second plurality of predicted referee interaction metrics from the additional trained referee interaction prediction machine learning model.

4. The computer-implemented method of claim 1, wherein generating the plurality of referrer client device tiers based on the plurality of predicted referee interaction metrics comprises:
generating a ranked order of the plurality of predicted referee interaction metrics; and
identifying tier thresholds based on the ranked order of the plurality of predicted referee interaction metrics.

5. The computer-implemented method of claim 1, further comprising:
generating a referrer client device tier database by aggregating measured referee client device interactions from the set of measured referee client device interactions according to the plurality of referrer client device tiers and referrer invitation values transmitted to historical referrer client devices corresponding to the measured referee client device interactions; and
generating, utilizing the optimization model, referrer invitation values corresponding to the plurality of referrer client device tiers based on the referrer client device tier database.

6. The computer-implemented method of claim 1, wherein transmitting the digital notifications comprises:
extracting client device features for a candidate referrer client device; and
generating, utilizing the trained referee interaction prediction machine learning model, a predicted referee interaction metric for the candidate referrer client device from the client device features.

7. The computer-implemented method of claim 6, wherein transmitting the digital notifications comprises:
selecting a referrer client device tier for the candidate referrer client device from the plurality of referrer client device tiers based on the predicted referee interaction metric for the candidate referrer client device; and
transmitting to the candidate referrer client device a digital notification comprising a referrer invitation value according to the digital notification distribution policy and the referrer client device tier.

8. The computer-implemented method of claim 1, further comprising generating the set of measured referee client device interactions for the plurality of referrer client device tiers by:
providing a set of digital notifications comprising referrer invitation values to a plurality of test referrer client devices; and
measuring interactions of referee client devices associated with test referrer client devices of the plurality of test referrer client devices.

9. The computer-implemented method of claim 1, further comprising training the trained referee interaction prediction machine learning model utilizing historical referrer client device features and a set of training referee client device interactions.

10. A non-transitory computer-readable medium storing instructions that, when executed by at least one processor, cause a computer system to:
generate, utilizing a trained referee interaction prediction machine learning model, a plurality of predicted referee interaction metrics from a plurality of referrer client device features;
generate a plurality of referrer client device tiers based on the plurality of predicted referee interaction metrics;
generate, utilizing an optimization model, a digital notification distribution policy for the plurality of referrer client device tiers from a set of measured referee client device interactions for the plurality of referrer client device tiers and a target interaction metric; and
transmit digital notifications to referrer client devices in accordance with the digital notification distribution policy and the plurality of referrer client device tiers.

11. The non-transitory computer-readable medium of claim 10, further comprising instructions that, when executed by the at least one processor, cause the computer system to generate the plurality of predicted referee interaction metrics by:
generating, utilizing the trained referee interaction prediction machine learning model, a first plurality of predicted referee interaction metrics; and
generating, utilizing an additional trained referee interaction prediction machine learning model, a second plurality of predicted referee interaction metrics.

12. The non-transitory computer-readable medium of claim 11, further comprising instructions that, when executed by the at least one processor, cause the computer system to generate the plurality of predicted referee interaction metrics by combining the first plurality of predicted referee interaction metrics from the trained referee interaction prediction machine learning model and the second plurality of predicted referee interaction metrics from the additional trained referee interaction prediction machine learning model.

13. The non-transitory computer-readable medium of claim 10, further comprising instructions that, when executed by the at least one processor, cause the computer system to generate the plurality of referrer client device tiers based on the plurality of predicted referee interaction metrics by:
generating a ranked order of the plurality of predicted referee interaction metrics; and
identifying tier thresholds based on the ranked order of the plurality of predicted referee interaction metrics.

14. The non-transitory computer-readable medium of claim 10, further comprising instructions that, when executed by the at least one processor, cause the computer system to:
generate a referrer client device tier database by aggregating measured referee client device interactions from the set of measured referee client device interactions according to the plurality of referrer client device tiers and referrer invitation values transmitted to historical referrer client devices corresponding to the measured referee client device interactions; and
generate, utilizing the optimization model, referrer invitation values corresponding to the plurality of referrer client device tiers based on the referrer client device tier database.

15. The non-transitory computer-readable medium of claim 10, further comprising instructions that, when executed by the at least one processor, cause the computer system to generate the set of measured referee client device interactions for the plurality of referrer client device tiers by:
providing a set of digital notifications comprising referrer invitation values to a plurality of test referrer client devices; and
measuring interactions of referee client devices associated with test referrer client devices of the plurality of test referrer client devices.

16. A system comprising:
at least one processor; and
at least one non-transitory computer-readable storage medium storing instructions that, when executed by the at least one processor, cause the system to:
generate, utilizing a trained referee interaction prediction machine learning model, a plurality of predicted referee interaction metrics from a plurality of referrer client device features;
generate a plurality of referrer client device tiers based on the plurality of predicted referee interaction metrics;
generate, utilizing an optimization model, a digital notification distribution policy for the plurality of referrer client device tiers from a set of measured referee client device interactions for the plurality of referrer client device tiers and a target interaction metric; and
transmit digital notifications to referrer client devices in accordance with the digital notification distribution policy and the plurality of referrer client device tiers.

17. The system of claim 16, further comprising instructions that, when executed by the at least one processor, cause the system to generate the plurality of predicted referee interaction metrics by:
generating, utilizing the trained referee interaction prediction machine learning model, a first plurality of predicted referee interaction metrics;
generating, utilizing an additional trained referee interaction prediction machine learning model, a second plurality of predicted referee interaction metrics; and
generating the plurality of predicted referee interaction metrics by combining the first plurality of predicted referee interaction metrics from the trained referee interaction prediction machine learning model and the second plurality of predicted referee interaction metrics from the additional trained referee interaction prediction machine learning model.

18. The system of claim 16, further comprising instructions that, when executed by the at least one processor, cause the system to transmit the digital notifications by:
extracting client device features for a candidate referrer client device; and
generating, utilizing the trained referee interaction prediction machine learning model, a predicted referee interaction metric for the candidate referrer client device from the client device features.

19. The system of claim 18, further comprising instructions that, when executed by the at least one processor, cause the system to transmit the digital notifications by:
selecting a referrer client device tier for the candidate referrer client device from the plurality of referrer client device tiers based on the predicted referee interaction metric for the candidate referrer client device; and
transmitting to the candidate referrer client device a digital notification comprising a referrer value according to the digital notification distribution policy and the referrer client device tier.

20. The system of claim 16, further comprising instructions that, when executed by the at least one processor, cause the system to train the trained referee interaction prediction machine learning model utilizing historical referrer client device features and a set of training referee client device interactions.
